(19) United States
(12) Patent Application Publication
(10) Pub. No.: US 2008/0269455 A1
(43) Pub. Date: Oct. 30, 2008

(54) Process for Production of Polybenzazole Polymer and the Polymer

(75) Inventors: Naoki Watanabe, Ohtsu-Shi (JP); Go Mastuoka, Ohtsu-shi (JP); Fuyuhiko Kubota, Ohtsu-shi (JP); Yukihiro Abe, Ohtsu-shi (JP); Yasuko Mitooka, Ohtsu-shi (JP)

Correspondence Address: MORRISON & FOERSTER LLP, 1650 TYSONS BOULEVARD, SUITE 400, MCLEAN, VA, 22102, US

(73) Assignee: Toyo Boseki Kabushiki Kaisha, Osaka-shi (JP)

(21) Appl. No.: 12/066,819

(22) PCT Filed: Sep. 11, 2006
(86) PCT No.: PCT/JP2006/317952

§ 371 Date: Apr. 16, 2008

(30) Foreign Application Priority Data
Sep. 13, 2005 (JP) 2005-265119
Sep. 13, 2005 (JP) 2005-265120
Mar. 2, 2006 (JP) 2006-056189
Mar. 2, 2006 (JP) 2006-056190

(51) Int. Cl. C08G 73/22

(52) U.S. Cl. 528/208; 528/271

(57) ABSTRACT

PROBLEMS The present invention relates to a process for producing a polybenzoxazole polymer and provides a process for producing the polybenzoxazole polymer within a short reaction time.
MEANS FOR SOLVING PROBLEMS A process for producing a polybenzazole polymer comprises producing the polybenzazole polymer in a non-oxidizing dehydrating solvent while employing a compound represented by the following general formula (1) as a raw material including a first polymerization step in which polymerization is performed at a temperature of 150° C. or less and a latter polymerization step in which polymerization is performed at a temperature of 200° C. or more, wherein at least the latter polymerization step is performed in a kneading-type reaction apparatus to complete the polymerization reaction:

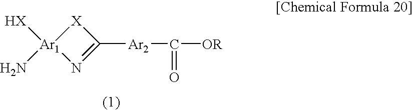

wherein X represents an O atom, an S atom or an NH group; Ar₁ represents a tetravalent organic group having two or less of benzene rings, naphthalene rings or pyridine rings; Ar₂ represents a bivalent organic group having two or less of benzene rings, naphthalene rings or pyridine rings; both of Ar₁ and Ar₂ may have one or more functional groups such as a methyl group and a hydroxyl group; and R represents H or a univalent organic group with a carbon number of 1 to 6.

### TECHNICAL FIELD

The present invention relates to a process for producing a polybenzazole polymer. For further details, the invention relates to a process for producing a polybenzazole polymer within a short reaction time.

### BACKGROUND ART

A polybenzoxazole polymer attracts attention as a polymer having greatly excellent heat resistance, strength and modulus of elasticity, and polymerization method thereof, film and molding into fiber are disclosed (refer to Patent Literatures 1 to 4 and Nonpatent Literature 1).

Patent Literature 1: U.S. Pat. No. 4,533,692 specification
Patent Literature 2: U.S. Pat. No. 4,847,350 specification
Patent Literature 3: U.S. Pat. No. 5,089,591 specification
Patent Literature 4: U.S. Pat. No. 5,075,392 specification

### Nonpatent Literature 1: Wolf et al, Macromolecules, 14, 909 (1981)

In the case of forming into fiber, for example, polyphosphoric acid solution of polybenzoxazole is extruded from a spinneret and shaped into fiber by passing through a phosphoric acid aqueous solution coagulating bath via an air gap to extract phosphoric acid by sufficiently washing in water and followed by drying, the polybenzoxazole fiber is obtained.

In the above-mentioned known art, a compound represented by the following general formula (2) and a derivative or a mineral acid salt thereof, and an aromatic dicarboxylic acid or a derivative thereof are used as a starting material. In order to obtain desired physical properties of a molded product, it is necessary that degree of polymerization be controlled with favorable accuracy to obtain a polymer having high degree of polymerization; thus, stoichiometric mixture ratio of the compound represented by the general formula (2) and the carboxylic acid has to be strictly controlled. In industrially producing, the control of this stoichiometric mixture ratio is a greatly important and is a technique of a high level difficulty.

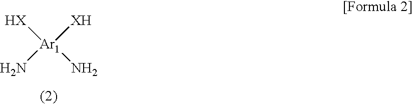

In the formula, X represents an O atom, an S atom or an NH group; and Ar₁ represents a tetravalent organic group having two or less of benzene rings or naphthalene rings.

Examples of a method for solving such difficulties include techniques described in the following Patent Literatures 5 and 6 and Nonpatent Literature 2.

That is, in Patent Literature 5, the example of polybenzoxazole is described: an oligomer having a low degree of polymerization is synthesized in a first step, and a monomer is added as a chain extender for obtaining an intended degree of polymerization in a second step. Thus, even though accuracy in controlling stoichiometric mixture ratio in the first step is roughened, a degree of polymerization can be adjusted with favorable accuracy in the second step. However, the problem is that this method requires long reaction processes and large equipment.

Also, in Patent Literature 6, a method for synthesizing a salt of diaminoresorcinol and aromatic dicarboxylic acid and polymerize the salt in polyphosphoric acid is disclosed. According to this method, diaminophenol and the dicarboxylic acid are previously bonded at a ratio of 1:1, so that the stoichiometric mixture ratio is controlled with great ease. However, the problem was that stability of the monomer salt was not necessarily sufficient and it took a long time for polymerization due to deterioration restraint.

On the other hand, in Nonpatent Literature 2, a method for polymerizing a compound obtained by reacting diaminoresorcinol with terephthalic acid at a ratio of 1:1 is disclosed. This method is an excellent method in which instability of the raw material is also solved; however, the problem was that it took as long a time as 24 hours or more to polymerize even in this method.

Thus, in the industrial production, the establishment of a producing technique for obtaining a polybenzoxazole polymer having a high degree of polymerization more efficiently has been strongly desired in view of economy.

Patent Literature 5: U.S. Pat. No. 5,194,568 specification
Patent Literature 6: U.S. Pat. No. 5,276,128 specification
Nonpatent Literature 2: Dotrong et al, J. polym. Sci part:A., 35, 3451 (1997)

### DISCLOSURE OF THE INVENTION

### Problems to be Solved by the Invention

The present invention has been made against the background of problems in the prior art, relates to a process for producing a polybenzazole polymer, and provides a process for producing stably within a short reaction time.

### Means for Solving the Problem

The inventors of the present invention have eventually completed the present invention through earnest studies for solving the above-mentioned problems. That is, a first aspect of the invention is a process for producing a polybenzazole polymer comprises producing the polybenzazole polymer in a non-oxidizing dehydrating solvent while employing a compound represented by the following general formula (1) as a raw material, including a first polymerization step in which polymerization is performed at a temperature of 150° C. or less and a latter polymerization step in which polymerization is performed at a temperature of 200° C. or more, wherein at least the latter polymerization step is performed in a kneading-type reaction apparatus to complete the polymerization reaction.

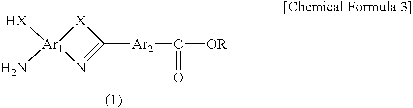

In the formula, X represents an O atom, an S atom or an NH group; Ar₁ represents a tetravalent organic group having two or less of benzene rings, naphthalene rings or pyridine rings; Ar₂ represents a bivalent organic group having two or less of benzene rings, naphthalene rings or pyridine rings; both of Ar₁ and Ar₂ may have one or more functional groups such as a methyl group and a hydroxyl group; and R represents H or a univalent organic group with a carbon number of 1 to 6.

A second aspect of the invention is a process for producing a polybenzoxazole polymer comprises producing the polybenzoxazole polymer in a non-oxidizing dehydrating solvent while employing as a raw material a compound such that in the above-mentioned general formula (1), wherein Ar₁ represents a tetravalent organic group having two or less of benzene rings or naphthalene rings, Ar₂ represents a bivalent organic group having two or less of benzene rings or naphthalene rings, and R represents H or a univalent organic group with a carbon number of 1 to 6, including a first polymerization step in which polymerization is performed at a temperature of 150° C. or less and a latter polymerization step in which polymerization is performed at a temperature of 200° C. or more, and wherein at least the latter polymerization step is performed in a kneading-type reaction apparatus to complete the polymerization reaction.

A third aspect of the invention is the process for producing a polybenzazole polymer according to first or second aspect of the invention, characterized in that the total polymerization reaction time is within 6 hours.

A fourth aspect of the invention is the process for producing a polybenzazole polymer according to any one of first to third aspects of the invention, characterized in that the non-oxidizing dehydrating solvent is a polymerization solvent selected from polyphosphoric acid, phosphorus pentoxide or methansulfonic acid and a mixture thereof, and contains a reducing agent.

A fifth aspect of the invention is a polybenzazole polymer obtained by the process according to any one of first to fourth aspects of the invention, characterized in that an intrinsic viscosity measured at 25° C. and 0.05 dl/g in the methansulfonic acid is 5 dl/g or more.

A sixth aspect of the invention is a polybenzazole polymer obtained by the process according to any one of first to fourth aspects of the invention, characterized in that an intrinsic viscosity measured at 25° C. and 0.05 dl/g is 20 dl/g or more.

### EFFECT OF THE INVENTION

According to the present invention, a polybenzazole polymer having a high degree of polymerization is produced efficiently and stably even within as short a time as 6 hours.

### BEST MODE FOR CARRYING OUT THE INVENTION

Firstly, a process for producing a polybenzazole polymer in the present invention is characterized by employing a compound represented by the following general formula (1) as a raw material.

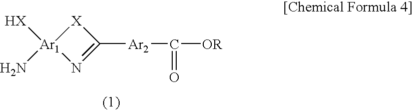

In the formula, X represents an O atom, an S atom or an NH group; Ar₁ represents a tetravalent organic group having two or less of benzene rings, naphthalene rings or pyridine rings; Ar₂ represents a bivalent organic group having two or less of benzene rings, naphthalene rings or pyridine rings; both of Ar₁ and Ar₂ may have one or more functional groups such as a methyl group and a hydroxyl group; and R represents H or a univalent organic group with a carbon number of 1 to 6.

Among the compounds represented by the above-mentioned general formula (1), specific examples of the preferable compounds include the following compounds. A carboxylic acid of these compounds may form ester with alcohol with a carbon number of 1 to 6. Also, these compounds may form a salt with strong acid, and occasionally preferably form a salt with phosphoric acid, polyphosphoric acid or the like. In addition, these may be used singly or some of them may be used in mixture. Also, other bishydroxyamine, an aromatic dicarboxylic acid and/or a derivative thereof may be used together within not more than 100% by mol of a constitutional unit of the polymer.

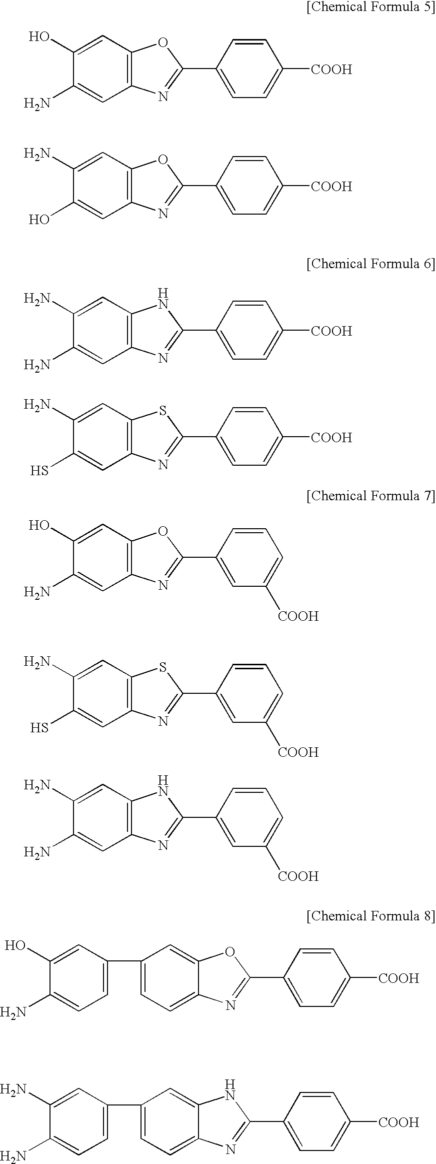

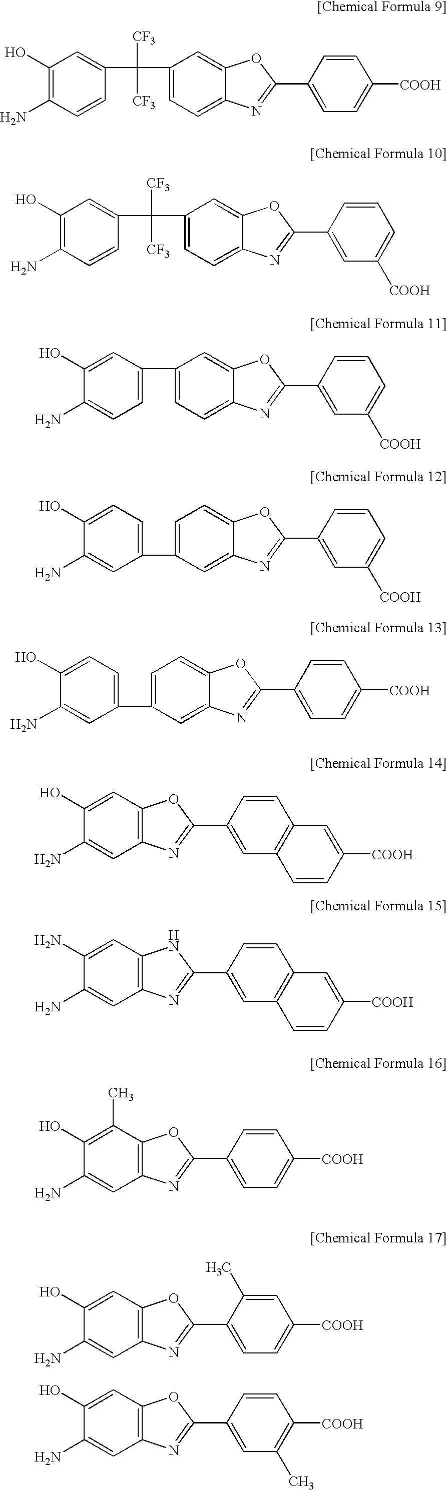

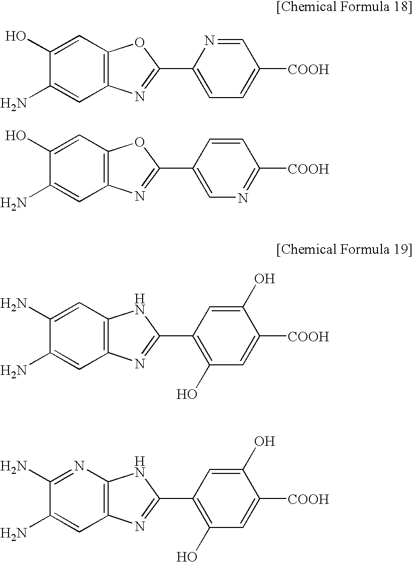

Preferable examples of the compound represented by the general formula (2) to be used together include 4,6-diaminoresorcinol, 2-methyl-4,6-diaminoresorcinol, 3,3′-dihydroxybenzidine, 4,4′-dihydroxybenzidine, 1,4-diamino-2,5-dithiol benzene, 1,2,4,5-benzene tetramine, 2,3,5,6-tetraminopyridine and the like.

Also, preferable examples of the aromatic dicarboxylic acid to be used together include terephthalic acid, isophthalic acid, 4,4′-bisbenzoic acid, 3,4′-bisbenzoic acid, 4,4′-oxybisbenzoic acid, 2,6-naphthalenedicarboxylic acid, 2,4-pyridinedicarboxylic acid, 2,5-pyridinedicarboxylic acid, 2,5-dihydroxyterephthalic acid, 2-methylterephthalic acid, and an acid chloride compound, a lower alcohol ester thereof and the like.

The compound represented by the general formula (1) to be employed for the present invention is preferably in the shape of particulates in view of solubility, and form and size thereof are not particularly limited. A median size measured by a light-scattering particle-size distribution analyzer is preferably 5 micrometers or more and 1 mm or less, more preferably 10 micrometers or more and 500 micrometers or less.

The solvent to be employed for the present invention needs to be a non-oxidizing solvent having dehydrating action. Conventionally known polyphosphoric acid and methansulfonic acid can be used, and dehydrating capacity and solubility of the polymer can be adjusted by properly adding phosphorus pentoxide.

Preferable solvent is a mixed solvent of polyphosphoric acid and phosphorus pentoxide, and a mixed solvent of methansulfonic acid and phosphorus pentoxide. The mixed solvent of polyphosphoric acid and phosphorus pentoxide is particularly preferable. In this case, the concentration of polyphosphoric acid is preferably 110% or more, more preferably 115% or more.

The concentration of the polymer is not particularly limited unless the polymer is precipitated, and a concentration such as to develop liquid crystallinity is preferable. Also in view of the productivity, the concentration is preferably high; 10% or more is preferable. However, the concentration is properly 20% or less for the reason that a high concentration raises viscosity of the solution too much.

Also, in the present invention, this solvent preferably contains a reducing agent. Preferable examples of the reducing agent include stannous chloride, zinc chloride and the like, and stannous chloride is particularly preferable by reason of no coloring. The amount of the reducing agent is not particularly limited, and 500 to 10000 ppm with respect to the polymer is preferable.

In the present invention, the compound represented by the general formula (1) may be added into a reaction solvent at one time or with division.

Though a degree of polymerization can be adjusted by adding the aromatic dicarboxylic acids or diaminophenols described above, a terminal stopper may be used. A benzoic acid, o-aminophenol and the like can be used as the terminal stopper. Such compounds for adjusting a degree of polymerization may be added from the initial stage of the polymerization or after the reaction progresses to some degree to form an oligomer.

In the present invention, it is important to appropriately set reaction temperature. Generally, the influence of temperature on reaction is greatly large, and higher temperature hastens reaction more. High temperature hastens polymerization reaction and simultaneously accelerates side reaction, particularly decomposition reaction of an amino group, so that the decomposition reaction is caused to increase relatively. This decomposition reaction tends to be restrained as molecular weight increases, that is, a degree of polymerization rises; therefore, it is important to appropriately set temperature profiles.

The first polymerization step in the present invention means a low polymerization degree step in which polymerization reaction solution becomes viscous slurry, and this polymerization temperature is 150° C. or less at which the polymerization reaction progresses, and polymerization conditions are preferably a temperature of 70° C. to 150° C. and a polymerization time of approximately 5 minutes to 3 hours.

The latter polymerization step means a step for making a product in low polymerization degree obtained in the first polymerization step into an intended product in high polymerization degree, and polymerization temperature is 200° C. or more. Polymerization conditions are preferably a temperature of approximately 200° C. to 250° C. and approximately 15 minutes to 4 hours for the reason that not merely is the polymerization reaction hastened but also the decomposition reaction is restrained.

In the present invention, the total polymerization reaction time including the first polymerization step and the latter polymerization step is preferably within 6 hours.

With regard to a reaction apparatus, a reactor vessel equipped with a general stirring apparatus, such as an anchor blade-type stirrer, a double helical ribbon blade-type stirrer or the like, may be used in the first polymerization step for the reason that the degree of polymerization is low and viscosity is not high, but the latter polymerization step requires kneading-type stirring capable of being performed even at high viscosity for the reason that the degree of polymerization is high and viscosity is high, and thus at least in the latter polymerization step, the polymerization reaction needs to be progressed in a kneading-type reaction apparatus.

Examples of such a kneading-type reaction apparatus include a planetary stirring apparatus provided with a double-arm-type stirrer, a reaction apparatus provided with a ribbon-type stirring blade capable of being stirring even at high viscosity, a biaxial extruder having self cleaning function, a horizontal-type feedfoward reactor with discharging mechanism and the like. Also, such reaction apparatuses can be used in proper combination in accordance with viscosity in each step of the reaction. In the latter polymerization step, particularly, the biaxial extruder is preferably used in view of stirring so easily even at high viscosity as to shorten the polymerization reaction time. The biaxial extruder is also excellent in the effect of hastening the polymerization reaction and restraining the decomposition reaction.

The polymer obtained in the present invention is required to have a degree of polymerization indicated by an intrinsic viscosity of 5 dl/g or more measured at a temperature of 25° C. by using an Ubbelohde viscometer, when the polymer is dissolved and diluted with distilled methansulfonic acid so that the polymer concentration becomes a concentration of 0.05 g/dl to measure an intrinsic viscosity. Also, depending on application, a degree of polymerization needs to be 20 dl/g or more, preferably 24 dl/g or more. Too high degree of polymerization occasionally brings too high viscosity in molding to deteriorate moldability, so that the upper limit thereof is preferably approximately 40 dl/g or less.

In the present invention, an additive agent may be added to polymer dope for providing functions such as to improve durability of the polymer and ameliorate adhesive property. The addition timing is not particularly limited but may be in the first step or the latter step of polymerization. Examples of the additive agent to be used include inorganic compound such as copper iodide, and organic compound such as phthalocyanine.

The polybenzazole polymer thus obtained can be processed into fiber and film by using conventionally known methods. For example, a method such as U.S. Pat. No. 4,533,683 prefers to be applied in the case of being processed into fiber.

### EXAMPLES

The present invention is hereinafter described in further details by examples and is not limited thereto.

### 1. Measurement of Intrinsic Viscosity

The polybenzazole polymer or polyphosphoric solution thereof was dissolved and diluted with distilled methansulfonic acid so that the polymer concentration becomes a concentration of 0.05 g/dl to measure intrinsic viscosity at a temperature of 25° C. by using an Ubbelohde viscometer.

### 2. Purity Evaluation of Aromatic Diamine by Method of HPLC Analysis

The measurement was performed by the following conditions. The purity was calculated by peak area ratio.

Apparatus: a system composed of the following parts manufactured by Hitachi, Ltd.

Liquid feed pump: L6200, Detector: L4200, High-temperature bath for column: L5020

Deaerator: L-5020, Integrator: D-2500

### Column: Zorbax-BP C8φ4.6×250 mm

Mobile phase: acetonitrile/water=5/5 (vol/vol),
phosphoric acid 0.0085 mol/l

Flow velocity: 1 ml/min

Detection: UV (230 nm)

Development temperature: 50° C.

Sample concentration: 1 mg/ml

Amount of sample injection: 20 μl

### Example 1

### Monomer Synthesis

4-[5-amino-6-hydroxybenzoxazole-2-yl]benzoic acid (ABA) synthesized by a method described in J. polym. Sci part:A., 35, 3451 (1997) was purified through recrystallization by employing methanol/DMF solvent, and a purified product having a purity of 99% or more measured by HPLC was used for the monomer synthesis.

### (Preparation of Polybenzoxazole)

Into a 50-l reactor vessel made of stainless steel equipped with a double helical ribbon blade-type stirrer, a solid content input port and a liquid input port, 26.49 kg of 116%-PPA, 3.50 kg of diphosphorus pentoxide, 5.77 kg (21.35 mol) of ABA prepared by the above-mentioned method and 200 g of stannous chloride were added and stirred for 3 hours while controlling the jacket temperature of the reactor vessel at 100° C. The viscous slurry thus prepared was supplied by using a gear pump to a biaxial extruder having five heating zones, which were set at temperatures of 150° C., 170° C., 200° C., 220° C. and 170° C. from the upstream side respectively. Concurrently, 20%-polyphosphoric acid solution of a benzoic acid was supplied as a terminal stopper until the concentration becomes 0.8% by mol with respect to the ABA by using a gear pump to the biaxial extruder. The discharge amount was adjusted so that average residence time in the biaxial extruder became 1 hour to perform polymerization reaction. The polymer dope sampled from the extruder outlet was diluted with methansulfonic acid to measure intrinsic viscosity, which was 34 dl/g. The color of the obtained polymer dope was yellow. In a 300-ml separable flask equipped with a ribbon-type blade, 100 g of this dope was put and further stirred while heated at a temperature of 200° C. for 3 hours; however, the intrinsic viscosity was not changed and it was confirmed that the reaction was completed.

### (Production of Polybenzoxazole Fiber)

The above-mentioned polymer dope was spun out by using a gear pump from a nozzle having a hole number of 334, a hole diameter of 0.22 mm and a spinneret area of 54.1 cm² on the conditions of a polymer dope discharge amount of 158 g/minute and a spinneret temperature of 185° C. to cool the line of thread by cooling air at a temperature of 60° C., which line was subsequently introduced into a coagulating bath of phosphoric acid aqueous solution, and rolled up with a godet roller. The line of thread rolled up was washed in water to extract phosphoric acid therefrom, which line was thereafter neutralized with sodium hydroxide aqueous solution, washed in water again and dried at a temperature of 200° C. The strength of the obtained polybenzoxazole fiber was 40 cN/dtex.

### Example 2

4-[5-amino-6-thioxybenzothiazole-2-yl]benzoic acid (ATBA) was purified through recrystallization by employing methanol/DMF solvent by the same method as a method described in J. polym. Sci part:A., 35, 3451 (1997), and a purified product having a purity of 99% or more measured by HPLC was used.

### (Preparation of Polybenzothiazole)

Into a 50-l reactor vessel made of stainless steel equipped with a double helical ribbon blade-type stirrer, a solid content input port and a liquid input port, 26.49 kg of 116%-PPA, 3.50 kg of diphosphorus pentoxide, 6.46 kg (21.35 mol) of ATBA prepared by the above-mentioned method and 200 g of stannous chloride were added and stirred for 3 hours while controlling the jacket temperature of the reactor vessel at 100° C. The viscous slurry thus prepared was supplied by using a gear pump to a biaxial extruder having five heating zones, which were set at temperatures of 120° C., 170° C., 220° C., 220° C. and 150° C. from the upstream side respectively. Concurrently, 20%-polyphosphoric acid solution of a benzoic acid was supplied as a terminal stopper until the concentration becomes 1.3% by mol with respect to the ATBA by using a gear pump to the biaxial extruder. The discharge amount was adjusted so that average residence time in the biaxial extruder became 1 hour to perform polymerization reaction. The polymer dope sampled from the extruder outlet was diluted with methansulfonic acid to measure intrinsic viscosity, which was 22 dl/g. The color of the obtained polymer dope was orange. In a 300-ml separable flask equipped with a ribbon-type blade, 100 g of the dope was put and further stirred while heated at a temperature of 200° C. for 3 hours; however, the intrinsic viscosity was not changed and it was confirmed that the reaction was completed.

### Example 3

The reaction was performed in the same manner as Example 1 except for modifying the temperature setting of the biaxial extruder into 120° C., 170° C., 220° C., 220° C. and 150° C. from the upstream side, and the average residence time in the biaxial extruder into 30 minutes. The color of the obtained polymer dope was yellow and the intrinsic viscosity thereof was 24 dl/g. In a 300-ml separable flask equipped with a ribbon-type blade, 100 g of this dope was put and further stirred while heated at a temperature of 200° C. for 3 hours; however, the intrinsic viscosity was not changed and it was confirmed that the reaction was completed.

### Example 4

Into a 50-l reactor vessel made of stainless steel equipped with a double-arm-type stirrer, a solid content input port and a liquid input port, 31.00 kg of 116%-PPA, 7.50 kg of diphosphorus pentoxide, 5.77 kg (21.35 mol) of ABA prepared by the above-mentioned method and 500 g of stannous chloride were added and stirred for 2 hours while controlling the jacket temperature of the reactor vessel at 140° C. The viscous slurry thus prepared was reacted on the same conditions as Example 1. The obtained polymer was yellow and the intrinsic viscosity thereof was 26 dl/g. In a 300-ml separable flask equipped with a ribbon-type blade, 100 g of the dope was put and further stirred while heated at a temperature of 200° C. for 3 hours; however, the intrinsic viscosity was not changed and it was confirmed that the reaction was completed.

### Example 5

The temperature of the 30-mmφ biaxial extruder having five heating zones was set at 130° C., 150° C., 220° C., 220° C. and 180° C. from the upstream side, and the number of revolutions and paddle constitution of the extruder were set so that the residence time therein became 1.5 hours. While 117%-polyphosphoric acid heated to a temperature of 100° C. was being supplied to a first zone at 20 cc/minute by a gear pump, ABA was supplied to the same first zone at a rate of 6 g/minute by using a screw-type powder supply apparatus.

20%-aminophenol/polyphosphoric acid solution was added to a fourth zone at a rate of 0.5 cc/minute. The intrinsic viscosity of the obtained polymer was 22 dl/g and the polymer color tone was yellow. In a 300-ml separable flask equipped with a ribbon-type blade, 100 g of the dope was put and further stirred while heated at a temperature of 200° C. for 3 hours; however, the intrinsic viscosity was not changed and it was confirmed that the reaction was completed.

### Example 6

The reaction was performed in the same manner as Example 1 except that 20%-polyphosphoric acid solution of a benzoic acid was supplied by using a gear pump to the biaxial extruder so as to become 2% by mol with respect to the ABA. The color of the prepared polymer dope was yellow and the intrinsic viscosity thereof was 15 dl/g. In a 300-ml separable flask equipped with a ribbon-type blade, 100 g of this dope was put and further stirred while heated at a temperature of 200° C. for 3 hours; however, the intrinsic viscosity was not changed and it was confirmed that the reaction was completed.

### Comparative Example 1

The reaction was performed in the same manner as Example 1 except for setting the temperature of the 50-1 reactor vessel made of stainless steel at 180° C. The color of the polymer dope was dark green and the intrinsic viscosity thereof was 17 dl/g. In a 300-ml separable flask equipped with a ribbon-type blade, 100 g of the dope was put and further stirred while heated at a temperature of 200° C. for 3 hours; however, the intrinsic viscosity was not changed and it was confirmed that the reaction was completed.

### (Production of Polybenzoxazole Fiber)

The above-mentioned polymer dope attempted to be spun out by using a gear pump from a nozzle having a hole number of 334, a hole diameter of 0.22 mm and a spinneret area of 54.1 cm² on the conditions of a polymer dope discharge amount of 158 g/minute and a spinneret temperature of 180° C.; however, thread breakage was frequently caused to result in poor productivity.

### Comparative Example 2

The reaction was performed in the same manner as Example 1 except for modifying the heater temperature setting of the biaxial extruder into 150° C., 180° C., 180° C., 180° C. and 170° C., and the average residence time into 1.5 hours. The intrinsic viscosity of the obtained polymer was as low as 8 dl/g. In a 300-ml separable flask equipped with a ribbon-type blade, 100 g of the dope was put and further stirred while heated at a temperature of 200° C. for 3 hours, accordingly, the intrinsic viscosity became 22 dl/g, it was confirmed that the reaction had not been completed in the biaxial extruder.

### Comparative Example 3

Into a 50-l reactor vessel made of stainless steel equipped with an anchor blade-type stirrer, a solid content input port and a liquid input port, 26.49 kg of 116%-PPA, 3.50 kg of diphosphorus pentoxide, 5.77 kg (21.35 mol) of ABA prepared by the above-mentioned method and 200 g of stannous chloride were added and stirred for 3 hours while controlling the jacket temperature of the reactor vessel at 100° C. The reaction was further performed at a temperature of 160° C. for 2 hours and thereafter at a temperature of 210° C. The polymer was sampled every other hour to measure intrinsic viscosity thereof. The intrinsic viscosity became the maximum 8 hours later, which was 22 dl/g. The polymer dope was discolored into green in places, and could not be taken out of the reactor vessel by reason of winding around the stirring blade.

### INDUSTRIAL APPLICABILITY

A process for producing a polybenzazole polymer of the present invention makes a great contribution to industry, such as reduction in production costs, by reason of being capable of producing stably within an unprecedentedly short time.

1. A process for producing a polybenzazole polymer comprising:
producing the polybenzazole polymer in a non-oxidizing dehydrating solvent while employing a compound represented by the following Chemical Formula (1) as a raw material including
a first polymerization step in which polymerization is performed at a temperature of 150° C. or less; and
a latter polymerization step in which polymerization is performed at a temperature of 200° C. or more, wherein
at least the latter polymerization step is performed in a kneading-type reaction apparatus to complete the polymerization reaction: 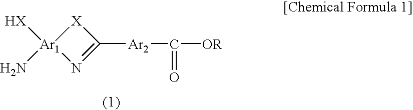
wherein X represents an O atom, an S atom or an NH group; Ar₁ represents a tetravalent organic group having two or less of benzene rings, naphthalene rings or pyridine rings; Ar₂ represents a bivalent organic group having two or less of benzene rings, naphthalene rings or pyridine rings; and R represents H or a univalent organic group with a carbon number of 1 to 6.

2. A process for producing a polybenzoxazole polymer comprising:
producing the polybenzoxazole polymer in a non-oxidizing dehydrating solvent while employing as a raw material a compound represented in the following Chemical Formula (1) 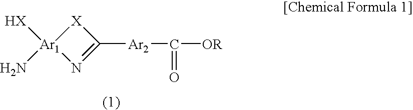
wherein Ar₁ represents a tetravalent organic group having two or less of benzene rings or naphthalene rings, Ar₂ represents a bivalent organic group having two or less of benzene rings or naphthalene rings, and R represents H or a univalent organic group with a carbon number of 1 to 6,
a first polymerization step in which polymerization is performed at a temperature of 150° C. or less and
a latter polymerization step in which polymerization is performed at a temperature of 200° C. or more, wherein
at least the latter polymerization step is performed in a kneading-type reaction apparatus to complete the polymerization reaction.

3. The process for producing a polybenzazole polymer according to claim 1, wherein the total polymerization reaction time is within 6 hours.

4. The process for producing a polybenzazole polymer according to claim 1, wherein the non-oxidizing dehydrating solvent is a polymerization solvent selected from the group consisting of polyphosphoric acid, phosphorus pentoxide or methansulfonic acid and mixtures thereof, and contains a reducing agent.

5. The process for producing a polybenzazole polymer according to claim 2, wherein the total polymerization reaction time is within 6 hours.

6. The process for producing a polybenzazole polymer according to claim 2, wherein the non-oxidizing dehydrating solvent is a polymerization solvent selected from the group consisting of polyphosphoric acid, phosphorus pentoxide or methansulfonic acid and mixtures thereof, and contains a reducing agent.

7. A polybenzazole polymer obtained by the process according to claim 1, wherein an intrinsic viscosity of the polybenzazole polymer is 5 dl/g or more.

8. The polybenzazole polymer according to claim 7, wherein the intrinsic viscosity is 20 dl/g or more.

9. A polybenzazole polymer obtained by the process according to claim 2, wherein an intrinsic viscosity of the polybenzazole polymer is 5 dl/g or more.

10. The polybenzazole polymer according to claim 9, wherein the intrinsic viscosity is 20 dl/g or more.
